(19) United States
(12) Patent Application Publication
(10) Pub. No.: US 2013/0210976 A1
(43) Pub. Date: Aug. 15, 2013

(54) FLUORINATED PHOSPHATES AS SURFACE ACTIVE AGENTS

(71) Applicants: SHENG PENG, Hockessin, DE (US); ALLISON MARY YAKE, Landenberg, PA (US); XIANJUN MENG, Hockessin, DE (US)

(72) Inventors: SHENG PENG, Hockessin, DE (US); ALLISON MARY YAKE, Landenberg, PA (US); XIANJUN MENG, Hockessin, DE (US)

(73) Assignee: E. I. DU PONT DE NEMOURS AND COMPANY, Wilmington, DE (US)

(21) Appl. No.: 13/372,032

(22) Filed: Feb. 13, 2012

(51) Int. Cl. C08K 5/521; C09D 167/06; C09D 201/00; C09D 175/04

(52) U.S. Cl. 524/144

(57) ABSTRACT

An improved method for lowering the surface tension of coating compositions wherein a surfactant is contacted with the coating composition, wherein the improvement comprises contacting said coating composition with a surfactant having mono-substituted fluorophosphates present at greater than or equal to 50 mol % than bis-substituted phosphates and substrates treated with the coating composition.

### FIELD OF INVENTION

The field of invention is related to the use of fluorochemical surfactants in coating compositions to impart surface effects to substrates coated with such compositions.

### BACKGROUND OF INVENTION

Commonly fluoroalkyl phosphate surfactants and surface treatment agents contain multiple fluorochemical chains, containing a higher percentage of fluorine at a given concentration and are typically used because they are thought to provide better performance. However, the fluorinated starting materials are more expensive and in short supply. Reduction of the amount of the fluorinated starting material in these surfactants while maintaining the same or better performance is desirable. Reducing the amount of the fluorinated starting component needed would not only reduce the cost, but also shorten the cycle time as fewer steps are needed in the production of the surfactants and less energy is required. Reducing the fluorine content would reduce the cost, but it is necessary to maintain product performance.

Brace and Mackenzie, in U.S. Pat. No. 3,083,224, describe mixed fluoroalkyl phosphates having the formula [CₘF₂ₘ₊₁ CₙH₂ₙO]_{y}PO(OM)_{3-y} where m is 4 to 12, n is 1 to 16, and y is averaged to be 1.0 to 2.5. Brace and Mackenze describe their use as an oil repellent, particularly when y is 2.

Montagna, et al., in EP 0 687 533, describe poly-perfluoroalkyleneoxide mono phosphate esters for use as oil and water repellency on different ceramics.

It is desirable to improve surfactant performance, in particular lowering of surface tension in coating compositions while using less fluorinated starting materials. It is also desirable to impart improved surface effects to coated surfaces. The present invention provides a method to increase surfactant performance and to impart improved surface effects to a coated surface while utilizing less fluorinated starting material.

### SUMMARY OF THE INVENTION

The present invention comprises an improved method for lowering the surface tension of coating compositions wherein a surfactant is contacted with said coating composition, wherein the improvement comprises contacting said coating compositions with a surfactant comprising formula I and formula II

(R_{f}AO)P(O)(O⁻M⁺)₂ (formula I)

and

(R_{f}AO)₂P(O)(O⁻M⁺) (formula II)

wherein

R_{f} is a C₁ to C₆ linear or branched perfluoroalkyl optionally interrupted by one, two or three ether oxygen atoms;

A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;

m is 0 to 4;

n, o, p, and r are each independently 2 to 20;

q is 2;

E is a C₂ to C₂₀ linear or branched alkyl group optionally interrupted by oxygen, sulfur, or nitrogen atoms; a cyclic alkyl group, or a C₆ to C₁₀ aryl group;

M is a Group I metal or an ammonium cation (NHₓR²_{y})⁺, wherein R² is a C₁ to C₄ alkyl; x is 1 to 4; y is 0 to 3; and x+y is 4; and wherein formula I is present at greater than or equal to 50 mol %.

The present invention further comprises a method of increasing the oil contact angle of a coating composition applied to a surface comprising contacting the surface with a coating composition comprising formula I and formula II as defined above wherein formula I is present at greater than or equal to 50 mol %.

The present invention further comprises a method of imparting surface effects to a coated substrate comprising contacting all or a portion of a surface of the substrate with a coating composition comprising formula I and formula II as defined above wherein formula I is present at greater than or equal to 50 mol %.

The present invention further comprises a coating composition and substrate from any of the above methods.

### DETAILED DESCRIPTION

Trademarks are shown herein in upper case.

The present invention comprises an improved method for lowering the surface tension of coating compositions wherein a surfactant is contacted with said coating composition, wherein the improvement comprises contacting said coating compositions with a surfactant comprising formula I and formula II

(R_{f}AO)P(O)(O⁻M⁺)₂ (formula I)

and

(R_{f}AO)₂P(O)(O⁻M⁺) (formula II)

wherein

R_{f} is a C₁ to C₆ linear or branched perfluoroalkyl optionally interrupted by one, two or three ether oxygen atoms;

A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;

m is 0 to 4;

n, o, p, and r are each independently 2 to 20;

q is 2;

E is a C₂ to C₂₀ linear or branched alkyl group optionally interrupted by oxygen, sulfur, or nitrogen atoms; a cyclic alkyl group, or a C₆ to C₁₀ aryl group;

M is a Group I metal or an ammonium cation (NHₓR²_{y})⁺, wherein R² is a C₁ to C₄ alkyl; x is 1 to 4; y is 0 to 3; and x+y is 4; and wherein formula (I) is present at greater than or equal to 50 mol %.

Compounds of formula I and formula II useful in the present invention can be prepared according to methods described by Longoria, et al., in U.S. Pat. No. 6,271,289, and Brace and Mackenzie, in U.S. Pat. No. 3,083,224. Typically, either phosphorus pentoxide (P₂O₅) or phosphorus oxychloride (POCl₃) is reacted with fluorinated alkyl alcohol or fluorinated alkyl thiol to give mixtures of the mono- and bis- (fluoroalkyl) phosphoric acids. The product is then neutralized using common bases such as ammonium or sodium hydroxides, or alkanol amines, such as, diethanolamine (DEA), to provide a mixture of the corresponding phosphates. Excess unreacted alcohol is removed via vacuum distillation. The ratio of fluorinated alcohol or fluorinated alkyl thiol with P₂O₅ is controlled to provide a composition useful as a surfactant in the present invention wherein the amount of compounds of formula I (mono(fluoroalkyl)phosphate) is equal to or greater than 50 mol % relative to the amount of compounds of formula II (bis(fluoroalkyl)phosphate). Preferably, formula I and formula II are present at a mol ratio of formula I to formula II of at least 2:1. More preferably, formula I and formula II are present at a mol ratio of formula I to formula II of at least 3:1.

The fluoroalkyl alcohol or fluoroalkyl thiol used as a reactant in the preparation of the surfactant useful in the present invention comprises compounds as described below for various embodiments. Preferred are surfactants comprising compounds of formula I and formula II wherein R_{f} is a C₃ to C₆ linear or branched perfluoroalkyl, and m is 1 to 4. More preferred are those surfactants comprising compounds of formula I and formula II wherein R_{f} is a C₂ to C₄ linear or branched perfluoroalkyl, and m is 1 to 3.

In one embodiment of the present invention, the surfactant comprises compounds of formula I and formula II wherein A is (CH₂CF₂)ₘ(CH₂)ₙ—, herein denoted as formula Ia and formula IIa,

(R_{f}CH₂CF₂)ₘ(CH₂)ₙO)P(O)(O⁻M⁺)₂ (formula Ia)

and

(R_{f}CH₂CF₂)ₘ(CH₂)ₙO)₂P(O)(O⁻M⁺) (formula IIa)

wherein

R_{f}, R¹, m, n, and M are as defined above. Preferred compounds of formula Ia and formula IIa include those wherein R_{f} is a C₄ or C₆ perfluoroalkyl, and n is 2.

Fluorinated alcohols useful in the preparation of surfactants used in various embodiments comprising compounds of formula Ia and formula IIa are available by synthesis according to the following scheme:

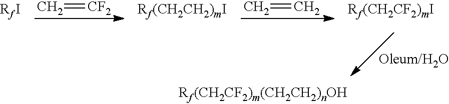

The telomerization of vinylidene fluoride (VDF) with linear or branched perfluoroalkyl iodides is well known, and produces compounds of the structure (R_{f}CH₂CF₂)ₘI, wherein, m is 1 to 3 or more and R_{f} is a C₁ to C₆ linear or branched perfluoroalkyl group. For example, see Balague, et al, “Synthesis of fluorinated telomers, Part 1, Telomerization of vinylidene fluoride with perfluoroalkyl iodides”, J. Flour Chem. (1995), 70(2), 215-23. The specific telomer iodides are isolated by fractional distillation. The telomer iodides can be treated with ethylene by procedures described in U.S. Pat. No. 3,979,469, (Ciba-Geigy, 1976) to provide the telomer ethylene iodides wherein n is 1 to 3 or more. The telomer ethylene iodides can be treated with oleum and hydrolyzed to provide the corresponding telomer alcohols according to procedures disclosed in WO 95/11877 (Elf Atochem S.A.). The higher homologs (n=2, 3) of telomer ethylene iodides are available with excess ethylene at high pressure. The telomer ethylene iodides can be treated with a variety of reagents to provide the corresponding thiols according to procedures described in J. Fluorine Chemistry, 104, 2 173-183 (2000). One example is the reaction of the telomer ethylene iodides with sodium thioacetate, followed by hydrolysis.

In a further embodiment of the present invention, the surfactant employed comprises compounds of formula I and formula II wherein A is (CH₂)ₒSO₂N(CH₃)(CH₂)ₚ, herein denoted as formula Ib and formula IIb,

(R_{f}(CH₂)ₒSO₂N(CH₃)(CH₂)ₚO)P(O)(O⁻M⁺)₂ (formula Ib)

and

(R_{f}(CH₂)ₒSO₂N(CH₃)(CH₂)ₚO)₂P(O)(O⁻M⁺) (formula IIb)

wherein

R_{f}, o, p, and M are as defined above in formula I. Preferred compounds of formula Ib and formula IIb include those wherein o and p are each 2, and R_{f} is a O₄ or C₆ linear or branched perfluoroalkyl. The fluoroalkyl alcohol used to prepare compounds of formula Ib and Ilb are available from E.I. du Pont de Nemours and Company, Wilmington Del. In a further embodiment of the present invention, the surfactant employed comprises compounds of formula I and formula II wherein A is O(CF₂)_{q}(CH₂)ᵣ, herein denoted as formula Ic and IIc,

(R_{f}O(CF₂)_{q}(CH₂)ᵣO)P(O)(O⁻M⁺)₂ (formula Ic)

and

(R_{f}O(CF₂)_{q}(CH₂)ᵣO)₂P(O)(O⁻M⁺) (formula IIc)

wherein

R_{f}, q, r, and M are as defined above in formula I. Preferred compounds of formula Ic and formula IIc include those wherein q and r are each 2, and R_{f} is C₃ linear or branched perfluoroalkyl.

The fluoroalcohols used as starting materials to make the compounds of formula Ic and IIc are available by the following series of reactions:

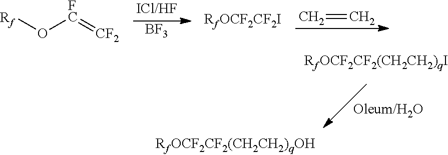

The starting perfluoroalkyl ether iodides of formula RfOCF═CF₂ can be made by the procedure described in U.S. Pat. No. 5,481,028, in Example 8, which discloses the preparation of compounds of formula RfOCF₂CF₂I from perfluoro-n-propyl vinyl ether.

The perfluoroalkyl ether iodide is then reacted with an excess of ethylene at an elevated temperature and pressure. While the addition of ethylene can be carried out thermally, the use of a suitable catalyst is preferred. Preferably the catalyst is a peroxide catalyst such as benzoyl peroxide, isobutyryl peroxide, propionyl peroxide, or acetyl peroxide. More preferably the peroxide catalyst is benzoyl peroxide. The temperature of the reaction is not limited, but a temperature in the range of 110° C. to 130° C. is preferred. The reaction time can vary with the catalyst and reaction conditions, but 24 hours is usually adequate. The product is purified by any means that separates unreacted starting material from the final product, but distillation is preferred. Satisfactory yields up to 80% of theory have been obtained using about 2.7 mols of ethylene per mole of perfluoroalkyl ether iodide, a temperature of 110° C. and autogenous pressure, a reaction time of 24 hours, and purifying the product by distillation.

The perfluoroalkylether ethylene iodides are then treated with oleum and hydrolyzed to provide the corresponding alcohols according to procedures disclosed in WO 95/11877 (Elf Atochem S.A.). Alternatively, the perfluoroalkylether ethyl iodides can be treated with N-methyl formamide followed by ethyl alcohol/acid hydrolysis. A temperature of about 130° to 160° C. is preferred. The higher homologs (q=2, 3) of telomer ethylene iodides are available with excess ethylene at high pressure.

The telomer ethylene iodides are treated with a variety of reagents to provide the corresponding thiols according to procedures described in J. Fluorine Chemistry, 104, 2 173-183 (2000). One example is the reaction of the telomer ethylene iodides with sodium thioacetate, followed by hydrolysis. The telomer ethylene iodide can also be treated to provide the corresponding thioethanols or thioethylamines by conventional methods.

In a further embodiment of the present invention, the surfactant comprises compounds of formula I and formula II wherein A is —OCHFCF₂OE-, herein denoted as formula Id and IId,

(R_{f}—OCHFCF₂OE-O)P(O)(O⁻M⁺)₂ (formula Id)

and

(R_{f}—OCHFCF₂OE-O)₂P(O)(O⁻M⁺) (formula IId)

wherein

R_{f}, E and M are as defined above in formula I. Preferred compounds of formula Id and formula IId include those wherein R_{f} is a C₃ linear or branched perfluoroalkyl.

The fluoroalcohols used as starting materials to make the compounds of formula Id and formula IId are prepared by reacting a dioxane, a fluoroalkyl containing at least 1 unsaturated bond, and a diol in the presence of an alkali metal compound. For example, 1,4-dioxane and a compound of formula R_{fOCF}═CF₂ are reacted with a diol, such as HO(CH₂)₂OH, in the presence of an alkali metal, such as KOH, typically in a sealed stainless steel reaction vessel at about 70° C. for about 8 hours. Further details are provided in U.S. Patent Application 2005/0107645, hereby incorporated by reference.

The present invention comprises an improved method for lowering the surface tension of coating compositions wherein a surfactant is contacted with said coating composition, wherein the improvement comprises contacting said coating compositions with a surfactant comprising formula I and formula II, as defined above, and wherein formula I is present at greater than or equal to 50 mol %. U.S. Pat. Nos. 3,083,224 and 4,145,382 disclose that surfactants containing a higher ratio of bis(fluoroalkyl)phosphates to mono(fluoroalkyl)phosphate are desirable and would perform better resulting in lower surface tensions. While this may be generally true for aqueous systems, surprisingly, the same does not prove to be true for coating compositions defined infra. The improved method of the present invention results in lowering of the surface tension of a coating composition with which a surfactant comprising formula I and formula II is contacted when more of formula I is present. This is due to the surface altering properties of the surfactant of formula I and formula II wherein the ratio of compounds of formula Ito formula II present is greater than or equal to 50 mol %, when compared to surfactants containing more formula II (bis(fluoroalkyl)phosphate) than formula I (mono(fluoroalkyl)phosphate).

The lowering of the surface tension of coating compositions to which such surfactant containing more of formula I is added results in increased wetting and leveling. “Leveling” as used herein refers to the uniformity of coverage of the coating when applied to a substrate. It is undesirable to have streaking, surface defects, or withdrawal of the coating from the substrate surface at the edges or otherwise. An even coating will provide a superior dried coating on the substrate surface. “Wetting” is the spreading of a coating composition over a surface. Uniformity in spreading is desirable to provide a superior dried uniform surface.

In the method of the present invention, contacting the surfactant, as defined above, with the coating composition is typically achieved by simply blending with or adding the surfactant to the coating composition. The contacting of the surfactant to the coating composition can occur prior to applying the coating composition to a substrate, or can occur after applying the coating composition to a substrate. In the present invention, a low concentration of about 0.1% by weight of surfactant is sufficient to lower surface tension of a coating composition to less than about 18 dyne/cm². Concentrations as low as 0.01% by weight of the surfactant in the coating composition are effective to achieve a surface tension of less than about 25 dyne/cm².

Suitable coating compositions, referred to herein by the term “coating composition” or “coating base”, include a composition, typically a liquid formulation, of an alkyd coating, Type I urethane coating, unsaturated polyester coating, or water-dispersed coating, and are applied to a substrate for the purpose of creating a lasting film on a substrate surface. These are conventional paints, stains, polishing agents, floor finishes, and similar coating compositions.

By the term “alkyd coating” as used herein is meant a conventional liquid coating based on alkyd resins, typically a paint, clear coating, or stain. The alkyd resins are complex branched and cross-linked polyesters containing unsaturated aliphatic acid residues. Conventional alkyd coatings utilize, as the binder or film-forming component, a curing or drying alkyd resin. Alkyd resin coatings contain unsaturated aliphatic acid residues derived from drying oils. These resins spontaneously polymerize in the presence of oxygen or air to yield a solid protective film. The polymerization is termed “drying” or “curing” and occurs as a result of autoxidation of the unsaturated carbon-carbon bonds in the aliphatic acid component of the oil by atmospheric oxygen. When applied to a surface as a thin liquid layer of formulated alkyd coating, the cured films that form are relatively hard, non-melting, and substantially insoluble in many organic solvents that act as solvents or thinners for the unoxidized alkyd resin or drying oil. Such drying oils have been used as raw materials for oil-based coatings and are described in the literature.

By the term “urethane coating” as used hereinafter is meant a conventional liquid coating based on Type I urethane resins, typically a paint, clear coating, or stain. Urethane coatings typically contain the reaction product of a polyisocyanate, usually toluene diisocyanate, and a polyhydric alcohol ester of drying oil acids. Urethane coatings are classified by ASTM D-1 into five categories. Type I urethane coatings contain a pre-reacted autoxidizable binder as described in Surface Coatings Vol. I, previously cited. These are also known as uralkyds, urethane-modified alkyds, oil-modified urethanes, urethane oils, or urethane alkyds, are the largest volume category of polyurethane coatings and include paints, clear coatings, or stains. The cured coating is formed by air oxidation and polymerization of the unsaturated drying oil residue in the binder.

By the term “unsaturated polyester coating” as used hereinafter is meant a conventional liquid coating based on unsaturated polyester resins, dissolved in monomers and containing initiators and catalysts as needed, typically as a paint, clear coating, or gel coat formulation. Unsaturated polyester resins contain as the unsaturated prepolymer the product obtained from the condensation polymerization of a glycol such as 1,2-propylene glycol or 1,3-butylene glycol with an unsaturated acid such as maleic (or of maleic and a saturated acid, e.g., phthalic) in the anhydride form. The unsaturated prepolymer is a linear polymer containing unsaturation in the chain. This is dissolved in a suitable monomer, for instance styrene, to produce the final resin. The film is produced by copolymerization of the linear polymer and monomer by means of a free radical mechanism. The free radicals can be generated by heat, or more usually by addition of a peroxide, such as benzoyl peroxide, separately packaged and added before use. Such coating compositions are frequently termed “gel coat” finishes. For curing coatings at room temperature, the decomposition of peroxides into free radicals is catalyzed by certain metal ions, usually cobalt. The solutions of peroxide and cobalt compound are added separately to the mix and well stirred before application. The unsaturated polyester resins that cure by a free radical mechanism are also suited to irradiation curing using, for instance, ultraviolet light. This form of cure, in which no heat is produced, is particularly suited to films on wood or board. Other radiation sources, for instance electron-beam curing, are also used.

By the term “water-dispersed coatings” as used herein is meant coatings intended for the decoration or protection of a substrate composed of water as an essential dispersing component such as an emulsion, latex, or suspension of a film-forming material dispersed in an aqueous phase. “Water-dispersed coating” is a general classification that describes a number of formulations and includes members of the above described classifications as well as members of other classifications. Water-dispersed coatings in general contain other common coating ingredients. Water-dispersed coatings are exemplified by, but not limited to, pigmented coatings such as latex paints, automotive base coats, industrial maintenance paints, unpigmented coatings such as clear wood sealers, stains, and finishes, industrial and automotive high gloss clear coatings, coatings for masonry and cement, and water-based asphalt emulsions. A water dispersed coating optionally contains surfactants, protective colloids and thickeners, pigments and extender pigments, preservatives, fungicides, freeze-thaw stabilizers, antifoam agents, agents to control pH, coalescing aids, and other ingredients. For latex paints the film forming material is a latex polymer of acrylate acrylic, vinyl-acrylic, vinyl, or a mixture thereof. Such water-dispersed coating compositions are described by C. R. Martens in “Emulsion and Water-Soluble Paints and Coatings” (Reinhold Publishing Corporation, New York, N.Y., 1965).

By the term “dried coating” as used herein is meant the final decorative and/or protective film obtained after the coating composition has dried, set or cured. Such a final film can be achieved by, for non-limiting example, curing, coalescing, polymerizing, interpenetrating, radiation curing, UV curing or evaporation. Final films can also be applied in a dry and final state as in dry coating.

Floor waxes, polishes, or finishes (hereinafter “floor finishes”) are generally water based or solvent based polymer emulsions. The surfactants used in the methods of the present invention are suitable for use in such floor finishes. Commercially available floor finish compositions typically are aqueous emulsion-based polymer compositions comprising one or more organic solvents, plasticizers, coating aides, anti-foaming agents, surfactants, polymer emulsions, metal complexing agents, and waxes. The particle size range and solids content of the polymer are usually controlled to control the product viscosity, film hardness and resistance to deterioration. Polymers containing polar groups function to enhance solubility and may also act as wetting or leveling agents providing good optical properties such a high gloss and distinctness of reflected image.

Preferred polymers for use in floor finishes include acrylic polymers, polymers derived from cyclic ethers, and polymers derived from vinyl substituted aromatics. Acrylic polymers include various poly(alkyl acrylates), poly(alkyl methacrylates), hydroxyl substituted poly(alkyl acrylates) and poly(alkyl methacrylates). Commercially available acrylic copolymers used in floor finishes include, for example, methyl methacrylate/butyl acrylate/methacrylic acid (MMA/BA/MAA) copolymers; methyl methacrylate/butyl acrylate/acrylic acid (MMA/BA/AA) copolymers, and the like. Commercially available styrene-acrylic copolymers include styrene/methyl methacrylate/butyl acrylate/methacrylic acid (S/MMA/BA/MMA) copolymers; styrene/methyl methacrylate/butyl acrylate/acrylic acid (S/MMA/BA/AA) copolymers; and the like. Polymers derived from cyclic ethers usually contain 2 to 5 carbon atoms in the ring with optional alkyl groups substituted thereon. Examples include various oxiranes, oxetanes, tetrahydrofurans, tetrahydropyrans, dioxanes, trioxanes, and caprolactone. Polymers derived from vinyl substituted aromatics include for example those made from styrenes, pyridines, conjugated dienes, and copolymers thereof. Polyesters, polyamides, polyurethanes and polysiloxanes are also used in floor finishes.

The waxes or mixtures of waxes that are used in floor finishes include waxes of a vegetable, animal, synthetic, and/or mineral origin. Representative waxes include, for example, carnuba, candelilla, lanolin, stearin, beeswax, oxidized polyethylene wax, polyethylene emulsions, polypropylene, copolymers of ethylene and acrylic esters, hydrogenerated coconut oil or soybean oil, and the mineral waxes such as paraffin or ceresin. The waxes typically range from 0 to about 15 weight percent and preferably from about 2 to about 10 weight percent based on the weight of the finish composition.

When the coating composition is a floor finish, the surfactants as defined above are effectively introduced to the coating composition by thoroughly stirring it in at room or ambient temperature. More elaborate mixing can be employed such as using a mechanical shaker or providing heat or other methods. When coating compositions are floor finishes, the surfactants generally are added at about 0.001 weight % to about 5 weight % by dry weight of the coating composition of the invention in the wet composition. Preferably about from about 0.005 weight % to about 2 weight %, more preferably from about 0.005 weight % to about 0.5 weight %, and even more preferably from about 0.01 weight % to about 0.05 weight % is used.

Floor waxes or polishes are water based, solvent based and polymer. The surfactants used in the present invention are suitable for use with any of these. Water-based and polymer waxes dry to a high gloss without buffing; solvent-based wax requires vigorous buffing. Water-based wax is recommended for asphalt, vinyl, vinyl asbestos and rubber-tiled floors; solvent-based waxes produce a hard, shiny finish and are best for wood, cork and terrazzo floors. Self-polishing waxes, such as polymer or resin, will yellow or discolor and wear off in heavy traffic areas; they should be stripped off and reapplied after three or four coats.

The surfactant comprising compounds of formula I and formula II, as defined above, are effectively contacted with the coating composition by thoroughly stirring it in at room or ambient temperature. More elaborate mixing can be employed such as using a mechanical shaker or providing heat or other methods. Such methods are not necessary and do not substantially improve the final composition. When the coating composition is latex paints, the surfactants comprising compounds of formula I and formula II are generally contacted at about 0.001 weight % to about 5 weight % by dry weight of the in the wet paint. Preferably about from about 0.01 weight % to about 1 weight %, and more preferably from about 0.1 weight % to about 0.5 weight % is used.

The present invention further comprises a method for increasing the contact angle of a coating composition applied to a surface comprising contacting the surface with a coating composition comprising formula I and formula II

(R_{f}AO)P(O)(O⁻M⁺)₂ (formula I)

and

(R_{f}AO)₂P(O)(O⁻M⁺) (formula II)

wherein

R_{f}, A, m, n, o, p, r, q, E, M, R², x, y, and the coating composition are as defined above; and wherein formula (I) is present at greater than or equal to 50 mol %. Preferably, formula I and formula II are present at a mol ratio of formula I to formula II of at least 2:1. More preferably, formula I and formula II are present at a mol ratio of formula I to formula II of at least 3:1. Preferably, R_{f} is O₄ to C₆ linear or branched perfluoroalkyl. The increase of the contact angle of the coated surface is due to the surface altering properties of the coating composition comprising compounds of formula I and formula II wherein the ratio of compounds of formula I to formula II present is greater than or equal to 50 mol % when compared to surfactants containing more bis(fluoroalkyl)phosphate than mono(fluoroalkyl) phosphate. The increasing of the contact angle of the coating composition results in increased anti-blocking, oil repellency, and resistance to dirt pickup in the dried coating.

The term “resistance to dirt pickup” or “dirt pickup resistance” is used herein to mean resistance by the dried coating to soiling. It is particularly applicable to coatings exposed to weather in that the coating resists soiling from dirt, debris, mold, and other conditions encountered in normal weather throughout the year. The level of dirt pickup resistance is indicated by the measurement of advancing oil contact angle. “Blocking” is the undesirable sticking together of two coated surfaces when pressed together, or placed in contact with each other for an extended period of time, after the coating has dried. When blocking occurs separation of the surfaces can result in disruption of the coating on one or both surfaces. Thus anti-blocking, also referred to as resistance to blocking, is beneficial in many situations where two coated surfaces need to be in contact, for example on window frames. “Oil repellency” is the ability of a surface coated with a coating composition according to the method of the present invention to not allow oil globules to spread. Oil repellency is determined by measuring the advancing angle when a drop of oil is placed in contact with a surface coated with a coating composition described above for use in the above described methods of the present invention.

The present invention further comprises a method for imparting surface effects to substrates comprising contacting all or a portion of a surface of the substrate with a coating composition containing a surfactant comprising formula I and formula II

(R_{f}AO)P(O)(O⁻M⁺)₂ (formula I)

and

(R_{f}AO)₂P(O)(O⁻M⁺) (formula II)

wherein

R_{f} is a C₁ to C₆ linear or branched perfluoroalkyl optionally interrupted by one, two or three ether oxygen atoms;

A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;

m is 0 to 4;

n, o, p, and r are each independently 2 to 20;

q is 2;

E is a C₂ to C₂₀ linear or branched alkyl group optionally interrupted by oxygen, sulfur, or nitrogen atoms; a cyclic alkyl group, or a C₆ to C₁₀ aryl group;

M is a Group I metal or an ammonium cation (NHₓR²_{y})⁺, wherein R² is a C₁ to C₄ alkyl; x is 1 to 4; y is 0 to 3; and x+y is 4; and wherein formula I is present at greater than or equal to 50 mol %.

The contacting of the coating composition with all or a portion of a surface of the substrate is achieved by conventional means. Non-limiting examples include application by brush, cloth, pad, spray, doctor blade, or other known means.

The amount of compounds of formula I (mono(fluoroalkyl) phosphate) is equal to or greater than 50 mol % relative to the amount of compounds of formula II (bis(fluoroalkyl)phosphate) in the coating composition. Preferably, formula I and formula II are present at a mol ratio of formula I to formula II of at least 2:1. More preferably, formula I and formula II are present at a mol ratio of formula I to formula II of at least 3:1. The compounds of formula I and formula II are added to the coating composition, typically as a mixture, as previously described. When the coating composition is latex paints, the surfactants comprising compounds of formula I and formula II are generally present at about 0.001 weight % to about 5 weight % by dry weight of the in the wet paint. Preferably about from about 0.01 weight % to about 1 weight %, and more preferably from about 0.1 weight % to about 0.5 weight % is used.

The surface properties imparted to the coated substrate are improved compared to a substrate coated with a composition containing a surfactant that comprises more bis(fluoroalkyl)phosphate than mono(fluoroalkyl) phosphate. The improved surface properties provided by the method of the present invention result from using a coating composition containing a surfactant having a greater amount of formula I than formula II. Such improved properties include a smoother more uniform coating due to increased wetting and leveling of the coating composition, and increased resistance to blocking, oil repellency, and dirt pickup resistance in the dried coating.

The present invention comprises a coating composition having improved wetting and leveling comprising a coating base and a surfactant of formula I and formula II

(R_{f}AO)P(O)(O⁻M⁺)₂ (formula I)

and

(R_{f}AO)₂P(O)(O⁻M⁺) (formula II)

wherein

R_{f}, A, m, n, o, p, r, q, E, M, R², x, y, and the coating composition are as defined above; and wherein formula (I) is present at greater than or equal to 50 mol %. The improved wetting and leveling provided by the present invention result from using a coating composition containing a surfactant having a greater amount of formula I than formula II compared to a coating composition containing a surfactant having a greater amount of formula II.

The present invention further comprises a substrate treated according to any of the above-described methods of the present invention.

One or more surfaces of the substrate have been contacted with a coating composition containing a surfactant comprising formula I and formula II

R_{f}AO)P(O)(O⁻M⁺)₂ (formula I)

and

(R_{f}AO)₂P(O)(O⁻M⁺) (formula II)

wherein

R_{f}, A, m, n, o, p, r, q, E, M, R², x, y, and the coating composition are as defined above; and wherein formula (I) is present at greater than or equal to 50 mol %.

Typical substrates include a wide variety of surfaces on which coating compositions are normally used. These include various construction materials, typically hard surfaced materials. The hard surface substrates include porous and non-porous mineral surfaces, such as glass, stone, masonry, concrete, unglazed tile, brick, porous clay and various other substrates with surface porosity. Specific examples of such substrates include unglazed concrete, brick, tile, stone including granite, limestone and marble, grout, mortar, statuary, monuments, wood, composite materials such as terrazzo, and wall and ceiling panels including those fabricated with gypsum board. In addition plastics, metals, ceramics, and other hard surfaces are included in the present invention. These are used in the construction of buildings, siding, roads, parking ramps, driveways, floorings, fireplaces, fireplace hearths, counter tops, walls, ceilings, decks, patios, furniture, fixtures, appliances, molded articles, shaped articles, decorative articles, and other items used in interior and exterior applications.

Other substrates include fibrous substrates. Most any fibrous substrate is suitable for treatment by the methods of the present invention. Such substrates include fibers, yarns, fabrics, fabric blends, textiles, carpet, rugs, nonwovens, leather and paper. The term “fiber” includes fibers and yarns, before and after spinning, of a variety of compositions and forms, and includes pigmented fibers and pigmented yarns. By “fabrics” is meant natural or synthetic fabrics, or blends thereof, composed of fibers such as cotton, rayon, silk, wool, polyester, polypropylene, polyolefins, nylon, and aramids such as “NOMEX” and “KEVLAR”. By “fabric blends” is meant fabric made of two or more different fibers. Typically these blends are a combination of at least one natural fiber and at least one synthetic fiber, but also can be a blend of two or more natural fibers and/or of two or more synthetic fibers.

The methods of the present invention are useful in improving the surface effects of various coating compositions and treated substrates. In particular the methods of the present invention are useful in coating compositions, such as floor finishes and paints. The methods of the present invention produce superior surface altering performance, such as, but not limited to wetting, leveling, resistance to blocking, oil repellency, and dirt pickup resistance, of coating compositions while requiring less fluorinated starting material as does the prior art compositions. This improved performance results in a reduced cost of raw materials and manufacturing as well as decreases cycle time.

### Materials and test methods

The following materials were used in the examples herein. C₆F₁₃CH₂CH₂OH and POCl₃ are available from Sigma Aldrich, St. Louis, Mo.

RHOPLEX 3829 floor polish, formulation N-29-1 is available from Dow Coating Materials, Midland, Mich.

Sherwin Williams MAB 024-1501 semi-gloss paint is commercially available from Sherwin Williams, Cleveland Ohio. That used in the Examples was purchased locally at Wilmington, Del.

### Test Method 1—Surface Tension Measurement

Surface tension was measured according to the American Society for Testing and Materials ASTM # D1331-56, using the Wilhelmy plate method on a KRUSS K11 Version 2.501 tensiometer (KRUSS USA, Matthews N.C.) in accordance with instructions with the equipment. A vertical plate of known perimeter was attached to a balance, and the force due to wetting was measured. Each example to be tested was added to a coating composition by weight based on solids of the additive in deionized water. Several different concentrations were prepared. Ten replicates were tested of each dilution, and the following machine settings were used:

### Method: Plate Method SFT

### Interval: 1.0 s

Wetted length: 40.2 mm
Reading limit: 10
Min Standard Deviation: 2 dynes/cm
Gr. Acc.: 9.80665 m/s²
Results were in dynes/cm (mN/m) with a Standard Deviation of less than 1 dyne/cm. The tensiometer was used according to the manufacturer's recommendations.

A stock solution was prepared for the highest concentration of surfactant in the coating composition to be analyzed. The concentration of the solution was by mol percent of the surfactant in a commercially available floor polish (RHOPLEX® 3829, Formulation N-29-1). The solutions are stirred overnight (for approximately 12 hours) to ensure complete mixing. Lower concentrations of the stock solution for each example were made by diluting the original stock solution. The floor polish is used for applications in the consumer, institutional, and industrial cleaning segments for demonstration of providing surface effects to substrates. Lower surface tension results indicate superior performance.

### Test Method 2—Contact Angle

Oil contact angles were measured by the Sessile Drop Method, which is described by A. W. Adamson in The Physical Chemistry of Surfaces, Fifth Edition, Wiley & Sons, New York, N.Y., 1990. Additional information on the equipment and procedure for measuring contact angles is provided by R. H. Dettre et al. in “Wettability”, Ed. by J. C. Berg, Marcel Dekker, New York, N.Y., 1993.

In the Sessile Drop Method, a Rame-Hart optical bench (available from Rame-Hart Inc., 43 Bloomfield Ave., Mountain Lakes, N.J.) was used to hold the substrate in the horizontal position. The contact angle was measured using hexadecane at a prescribed temperature with a telescoping goniometer from the same manufacturer. Each Example to be tested was added to MAB paint at 0.018% by weight based on solids of the additive in the paint. A drop of test liquid was placed on a polyester scrub test panel (Leneta P-121 dull black or equivalent, Leneta Company, Mahwah, N.J.) and the tangent was precisely determined at the point of contact between the drop and the surface. An advancing angle was determined by increasing the size of the drop of liquid. The data were presented as advancing contact angles. The liquid or oil used was n-hexadecane.

### EXAMPLES

### Example 1

In a round-bottom 100 mL flask equipped with a thermocouple and magnetic stirrer bar, POCl₃ (0.61 g, 4 mmol) was dissolved in anhydrous THF (25 mL). A solution containing C₆F₁₃CH₂CH₂OH (2.93 g, 8 mmol), and triethylamine (1 g, 10 mmol) in anhydrous THF (15 mL) was then slowly added to the reactor. The reaction was held 1 to 2 hours at 0° C. and stirred overnight at room temperature. The solids were then filtered and the solvent evaporated by high vacuum. The resulting oil was diluted into NH₄OH aqueous solution (30% NH₃, 4 mmol) and the pH was adjusted to 8˜8.5. A sample of the product of Example 1 was characterized as having a ratio of mono(fluoroalkyl) phosphate to bis(fluoroalkyl)phosphate of greater than 9 to 1. A sample of the product of Example 1 was added to RHOPLEX 3829 floor polish and tested according to Test Method 1 for surface tension at various concentrations. A sample of the product of Example 1 was also added to Sherwin Williams MAB 024-1501 semi-gloss paint and tested according to Test Method 2 for contact angle measurement. Test results are listed in Tables 2 and 3.

### Examples 2 to 4

Example 2 to 4 were prepared as described in Example 1, with different ratios of POCl₃ to C₆F₁₃CH₂CH₂OH, and produced products having the ratios of mono(fluoroalkyl)phosphates to bis(fluoroalkyl)phosphates as listed in Table 1. A sample of the product of each of Examples 2 to 4 was added to RHOPLEX 3829 floor polish and tested according to Test Method 1 for surface tension at various concentrations. A sample of the product of each of Examples 2 to 4 was also added to Sherwin Williams MAB 024-1501 semi-gloss paint and tested according to Test Method 2 for contact angle measurement. Test results are listed in Tables 2 and 3.

### Comparative Examples A to C

Comparative Examples A to C were prepared as described in Example 1, with different ratios of POCl₃ to C₆F₁₃CH₂CH₂OH, and produced products having ratios mono(fluoroalkyl)phosphates to bis(fluoroalkyl)phosphates as listed in Table 1. These Examples contained greater amounts of bis(fluoroalkyl)phosphates. A sample of the product of each of Comparative Examples A to C was added to RHOPLEX 3829 floor polish and tested according to Test Method 1 for surface tension at various concentrations. A sample of the product of each of Comparative Examples A to C was also added to Sherwin Williams MAB 024-1501 semi-gloss paint and tested according to Test Method 2 for contact angle measurement. Test results are listed in Tables 2 and 3.

TABLE 1

| Example | Mol Ratio of Mono:Bis |
|---|---|
| 1 | >9:1 |
| 2 | 3:1 |
| 3 | 2:1 |
| 4 | 1:1 |
| Comparative A | 1:1.1 |
| Comparative B | 1:4 |
| Comparative C | 1:>9 |

TABLE 2
Surface tension of floor polish

| | Surface Tension (at 23° C.), dynes/cm² (mN/m) | | | | |
|---|---|---|---|---|---|
| | Concentration of surfactant in floor polish, % by weight | | | | |
| Example | 0.0000% | 0.001% | 0.0100% | 0.1000% | 0.5000% |
| 1 | 32.4 | 30.4 | 24.6 | 17.1 | not tested |
| 2 | 32.3 | 30.4 | 24.8 | 16.9 | not tested |
| 3 | 32.5 | 30.1 | 24.6 | 17.8 | 16.7 |
| 4 | 32.2 | 30.6 | 25 | 18.3 | 17.2 |
| A | 32.4 | 31.2 | 27.8 | 18.5 | 17.1 |
| B | 32.4 | 29.8 | 28.7 | 22.1 | 17.3 |
| C | 32.4 | 31.8 | 29.9 | 21.9 | 18 |

Surface tensions of the coating compositions (RHOPLEX 3829) containing a surfactant having a ratio of 1:1 to >9:1 of mono(fluoroalkyl) phosphates to bis(fluoroalkyl)phosphate (Examples 1 to 4) were lower for the concentrations tested compared to coating compositions having higher amounts of bis(fluoroalkyl)phosphates (Comparative Examples A to C). The lower surface tension was indicative of superior wetting and leveling properties.

TABLE 3
Oil contact angle of paint containing surfactant

| | Contact |
|---|---|
| Example | angle |
| 1 | 89.4 |
| 2 | 81.5 |
| 3 | 74.2 |
| 4 | 68.0 |
| Comparative A | 67.6 |
| Comparative B | 64.7 |
| Comparative C | 61.7 |

Contact angles of the coating compositions (Sherwin Williams MAB 024-1501 semi-gloss paint) containing a surfactant having a ratio of 1:1 to >9:1 mono(fluoroalkyl) phosphates to bis(fluoroalkyl)phosphate (Examples 1 to 4) were greater than the coating compositions having higher amounts of bis(fluoroalkyl) phosphates (Comparative Examples A to C). Larger oil contact angles were indicative of better anti-blocking, oil repellency, and dirt pickup resistance.

What is claimed is:

1. An improved method for lowering the surface tension of coating compositions wherein a surfactant is contacted with said coating composition, wherein the improvement comprises contacting said coating composition with a surfactant comprising formula I and formula II
(R_{f}AO)P(O)(O⁻M⁺)² (formula I)
and (R_{f}AO)₂P(O)(O⁻M⁺) (formula II)
wherein
R_{f} is a C₁ to C₆ linear or branched perfluoroalkyl optionally interrupted by one, two or three ether oxygen atoms;
A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;
m is 0 to 4;
n, o, p, and r are each independently 2 to 20;
q is 2;
E is a C₂ to C₂₀ linear or branched alkyl group optionally interrupted by oxygen, sulfur, or nitrogen atoms; a cyclic alkyl group, or a C₆ to C₁₀ aryl group;
M is a Group I metal or an ammonium cation (NHₓR²_{y})⁺ wherein R² is a C₁ to C₄ alkyl; x is 1 to 4; y is 0 to 3; and x+y is 4; and
wherein formula (I) is present at greater than or equal to 50 mol %.

2. The method of claim 1 wherein formula I and formula II are present at a mol ratio of formula I to formula II of at least 2:1.

3. The method of claim 1 wherein the formula I and formula II are present at a mol ratio of formula I to formula II of at least 3:1.

4. The method of claim 1 wherein R_{f} is O₄ to C₆ linear or branched perfluoroalkyl.

5. The method of claim 1 wherein the coating composition is selected from the group consisting of an alkyd coating, Type I urethane coating, unsaturated polyester coating, or water-dispersed coating.

6. The method of claim 5 wherein the coating composition is floor finish, polishing agent, floor polish, or paint.

7. The method of claim 1 wherein the coating composition is applied to a substrate prior to contacting with the surfactant.

8. A method of increasing contact angle of a coating composition applied to a surface comprising contacting the surface with a coating composition comprising formula I and formula II
(R_{f}AO)P(O)(O⁻M⁺)₂ (formula I)
and (R_{f}AO)₂P(O)(O⁻M⁺) (formula II)
wherein
R_{f} is a C₁ to C₆ linear or branched perfluoroalkyl optionally interrupted by one, two or three ether oxygen atoms;
A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;
m is 0 to 4;
n, o, p, and r are each independently 2 to 20;
q is 2;
E is a C₂ to C₂₀ linear or branched alkyl group optionally interrupted by oxygen, sulfur, or nitrogen atoms; a cyclic alkyl group, or a C₆ to C₁₀ aryl group;
M is a Group I metal or an ammonium cation (NHₓR²_{y})⁺ wherein R² is a C₁ to C₄ alkyl; x is 1 to 4; y is 0 to 3; and x+y is 4; and
wherein formula (I) is present at greater than or equal to 50 mol %.

9. The method of claim 8 wherein formula I and formula II are present at a mol ratio of formula I to formula II of at least 2:1.

10. The method of claim 8 wherein R_{f} is C₄ to C₆ linear or branched perfluoroalkyl.

11. The method of claim 8 wherein the coating composition is selected from the group consisting of an alkyd coating, Type I urethane coating, unsaturated polyester coating, or water-dispersed coating.

12. The method of claim 11 wherein the coating composition is floor finish, polishing agent, floor polish, or paint.

13. The method of claim 8 wherein the contacting increases wetting and leveling in the coating composition.

14. A method for imparting surface effects to substrates comprising contacting all or a portion of a surface of the substrate with a coating composition containing a surfactant comprising formula I and formula II
(R_{f}AO)P(O)(O⁻M⁺)₂ (formula I)
and
(R_{f}AO)₂P(O)(O⁻M⁺) (formula II)
wherein
R_{f} is a C₁ to C₆ linear or branched perfluoroalkyl optionally interrupted by one, two or three ether oxygen atoms;
A is (CH₂CF₂)ₘ(CH₂)ₙ, (CH₂)ₒSO₂N(CH₃)(CH₂)ₚ, O(CF₂)_{q}(CH₂)ᵣ, or OCHFCF₂OE;
m is 0 to 4;
n, o, p, and r are each independently 2 to 20;
q is 2;
E is a C₂ to C₂₀ linear or branched alkyl group optionally interrupted by oxygen, sulfur, or nitrogen atoms; a cyclic alkyl group, or a C₆ to C₁₀ aryl group;
M is a Group I metal or an ammonium cation (NHₓR²_{y})⁺, wherein R² is a C₁ to C₄ alkyl; x is 1 to 4; y is 0 to 3; and x+y is 4; and wherein formula I is present at greater than or equal to 50 mol %.

15. The method of claim 14 wherein formula I and formula II are present at a mol ratio of formula I to formula II of at least 2:1.

16. The method of claim 14 wherein R_{f} is C₄ to C₆ linear or branched perfluoroalkyl.

17. The method of claim 14 wherein the coating composition is selected from the group consisting of an alkyd coating, Type I urethane coating, unsaturated polyester coating, or water-dispersed coating.

18. The method of claim 14 wherein the surface effect is resistance to blocking, oil repellency, or dirt pickup resistance.

19. A coating composition treated in accordance with the method of claim 1.

20. A substrate treated in accordance with the method of claim 14.
